(19) United States
(12) Patent Application Publication
(10) Pub. No.: US 2007/0024815 A1
(43) Pub. Date: Feb. 1, 2007

(54) Optical integrator

(75) Inventor: Yasuto Oyama, Saitama-shi (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/488,593

(22) Filed: Jul. 19, 2006

(30) Foreign Application Priority Data
Jul. 22, 2005 (JP) P2005-212641

(51) Int. Cl. G03B 21/18

(52) U.S. Cl. 353/54

(57) ABSTRACT

An optical integrator, which may be for a DLP system projector, is provided and includes an integral rod, a rod storage case, a resin housing, and a heat sink. The rod storage case includes an optical tube and covers. A sealed room formed between the optical tube and the rod outer surface of the integral rod is filled with a cooling liquid. A boss is formed on the top surface of the rod storage case. A penetration hole is formed in the resin housing and a penetration hole is formed in the heat sink. The rod storage case and the heat sink are coupled together so as to pinch the resin housing. The heat of the cooling liquid in the sealed room is dissipated from the resin housing through the boss and the heat sink. It is thus possible to efficiently cool the integral rod.

### FIELD OF THE INVENTION

The present invention relates to an optical integrator for making uniform the illuminance distribution of illumination light irradiated from a light source.

### BACKGROUNG OF THE INVENTION

As a projector for projecting image light on a screen to displaying the image on the screen, one using a digital micro mirror device (hereinafter referred to as the DMD) is known. A projector of the digital light processing (hereinafter referred to as DLP) system using the DMD modulates illumination light irradiated from an illumination optical system to image light by way of DMD and projects the modulated image light on a screen by using a projection optical system to display the image on the screen.

The DLP-system projector is generally equipped with an optical integrator and a relay lens constituting an illumination optical system between a light source for irradiating illumination light and a DMD. The optical integrator generally includes an integral rod extending in a direction parallel to the illumination optical axis of illumination light and a rod storage case for storing the integral rod.

As an integral rod, a hollow rod is often used having a structure where glass plates with reflective coating applied are combined in a substantially rectangular shape so that the reflective surfaces thereof will face inward (refer to JP-A-2004-354925 (FIG. 6, Page 5)). Illumination light incident on the integral rod is internally reflected on the inner surface of the rod and has its illuminance distribution made uniform, and is irradiated on the DMD through a relay lens. In this practice, to display a quality image on the screen, bright uniform illumination light is preferably irradiated on the DMD. To this end, the illumination light irradiated from a light source has preferably high illuminance and uniform intensity. Thus, the light source generally uses a high illuminance discharge lamp such as an ultrahigh pressure mercury lamp, a halide lamp, or a xenon lamp.

Using a high illuminance discharge lamp as a light source increases the amount of unwanted infrared rays included in the illumination light thus raising the temperature of an optical integrator. In particular, when the temperature of an integral rod rises, its optical performance could be degraded or the rod could be damaged. To offset this drawback, an integral rod using a combination of heat-resistant glass plates has been used. Such a heat-resistant glass plate is expensive and hard to process thus resulting in a higher manufacturing cost of the optical integrator.

It is a common practice to cool the optical integrator to keep its temperature from rising. For example, as described in JP-A-2003-195135 (FIG. 1, Page 9), a method is known for cooling an optical integrator by providing an air intake fan in the projector and letting the air taken from outside the projector by way of the air intake fan flow into the optical integrator. As described in Japanese Patent No. 3589856 (FIG. 1, Page 4), a method is also known for cooling the optical integrator by making an air blow hole and an air exhaust hole in a rod storage case and feeding cool air between the integral rod and the rod storage case from the air blow hole.

The method described in JP-A-2003-195135 requires an air intake fan and an air blow channel for guiding the air sucked by the air intake fan to the optical integrator, which results in a higher manufacturing cost of the projector. Further, foreign matter in the air sucked by the air intake fan could enter the light receiving opening of the integral rod. This could allows the foreign matter adhere to the inner surface of the rod thus degrading the optical performance of the integral rod.

In the method described in Japanese Patent No. 3589856, cool air fed from the air blow hole to the rod storage case is exhausted from the air exhaust hole. This stirs up dust and foreign matter accumulated inside the projector. As a result, the stirred up dust and foreign matter adhere to the other relay lenses, DMD and projection optical system, which could degrade their optical performances.

### SUMMARY OF THE INVENTION

An object of an illustrative, non-limiting embodiment of the invention is to provide an optical integrator, which can be cooled efficiently and is excellent in terms of dustproof capability.

An optical integrator according to an embodiment of the invention includes: an integral rod on an optical axis of illumination light irradiated from a light source, the integral rod extending in a direction parallel to the optical axis and making the illumination light entering therein to have a uniform illuminance distribution, a storage case including: a tubular body that houses the integral rod, wherein the tubular body covers an outer surface of the integral rod parallel to the optical axis with a spacing from the outer surface of the integral rod; and two lids, each of the two lids occupying a gap between an opening of the tubular body and the outer surface of the integral rod so as to form a sealed room with the tubular body, the outer surface of the integral rod and the two lids, and a cooling liquid filled in the room.

Further, the optical integrator according to an embodiment of the invention may include a housing that houses the storage case, the housing having a penetration hole in one wall thereof, the one wall constituting a plane of the housing; a retaining member on an outer surface of the housing, the retaining member engaging with the penetration hole to retain the storage case on an inner surface of the one wall, a part of the retaining member being exposed outside of an outer surface of the one wall through the penetration hole; and a heat sink in contact with the part of the retaining member exposed outside of the outer surface of the one wall. Further, the retaining member may have a cooling liquid flow-in room connecting to the sealed room. The one wall of the housing may be included in a top surface of the housing.

The integral rod may be a hollow rod having: a light-receiving opening in which the illumination light from the light source enters; an inner surface that internally reflects the illumination light entering from the light-receiving opening to make the illumination light uniform; a light-emitting opening from which the illumination light made uniform is emitted; and an outer surface having a plurality of heat-radiating fins, each of the heat-radiating fins having a long plate-like shape and protruding from the outer surface. Further, each of the heat-radiating fins may extend in a direction orthogonal to the optical axis.

The storage case may have a flow outlet and flow inlet of the cooling liquid, the flow outlet and flow inlet connecting to the sealed room, and the optical integrator may include: a circulating unit that circulates the cooling liquid to flow out of the storage case through the flow outlet and to flow into the storage case through the flow inlet; and a cooling unit that cools the cooling liquid flowing out through the flow outlet.

An optical integrator according to an embodiment of the invention forms a sealed room between an integral rod and tubular body covering the outer surface of the integral rod and fills the sealed room with a cooling liquid. This efficiently cools the integral rod. As a result, it is possible to suppress a rise in the temperature of the integral rod even in case a high illuminance discharge lamp is used as a light source. This allows the integral rod to be formed with optical glass that is low-cost and easy to process. The above structure of the optical integrator provides improved dustproof capability.

The optical integrator can have, on the outer surface of the tubular body, a retaining member for engaging a penetration hole formed in one wall of the tubular body to retain the storage case on the inner surface of the one wall and a heat sink in contact with the retaining member exposed outside of the outer surface of the one wall through the penetration hole. This can dissipate the heat of the cooling liquid that is heated outside the housing through the retaining member and the heat sink.

A liquid flow-in room connecting the sealed room can be formed inside the retaining member. This also can dissipate the heat of the cooling liquid outside the housing.

The one wall may be the top surface of the housing. It is thus possible to dissipate the heat of the cooling liquid outside of the housing by using the convection of the cooling liquid.

A hollow rod can be used as the integral rod and a plurality of heat-radiating fins having a long plate-like shape are protruded on the outer surface of this hollow rod. This can efficiently cool the integral rod.

The heat-radiating fins may extend in a direction orthogonal to the optical axis, which can eliminate the fear of convection of the cooling liquid being obstructed.

The cooling liquid can circulate through the flow outlet and flow inlet formed in the storage case to cool the cooling liquid expelled from the flow outlet. This can also efficiently cool the integral rod.

### BRIEF DESCRIPTION OF THE DRAWINGS

FIG. 1 is a schematic view of a DLP-system projector.

FIG. 2 is a perspective view of an optical integrator according to an exemplary embodiment of the invention.

FIG. 3 is an exploded perspective view of an optical integrator according to an exemplary embodiment of the invention.

FIG. 4 is a cross-sectional view along the line IV-IV in FIG. 2.

FIG. 5 is a perspective view of an optical integrator according to another exemplary embodiment of the invention.

FIG. 6 is a cross-sectional view of an optical integrator according to another exemplary embodiment where a circulating device is provided.

### DETAILED DESCRIPTION OF THE INVENTION

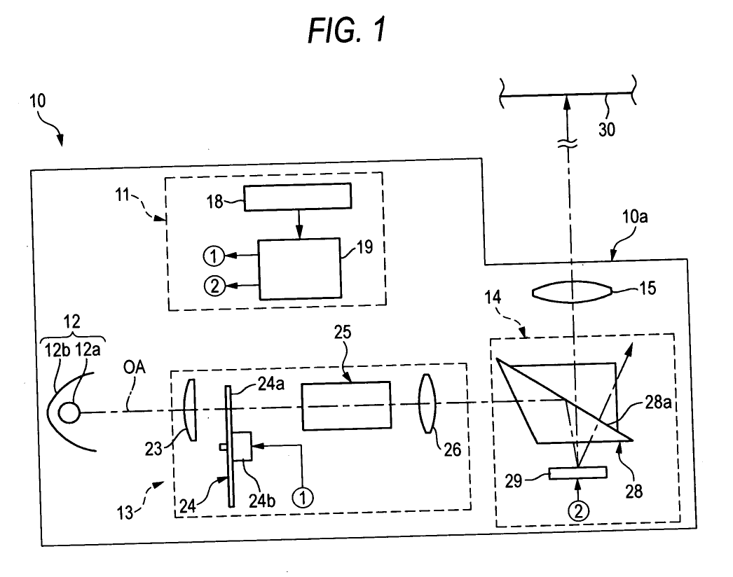

FIG. 1 is a schematic view of a DLP-system projector (hereinafter simply referred to as a projector). A projector 10 is a single-plate projector for generating image light of three colors with single DMD. The projector 10 includes a controller 11, a light source unit 12, an illumination optical system 13, an image light generating unit 14, and a projection optical system 15 accommodated in a projector housing 10a.

The controller 11 includes a picture signal receiver 18 and a microcomputer 19. To the picture signal receiver 18 are input pictures signals such as a composite signal and a component signal from a tuner of a video player connected to an external input terminal. The microcomputer 19 controls driving of each part of the projector 10 based on the picture signal input to the picture signal receiver 18.

The light source unit 12 includes a light source 12a and a reflector 12b for reflecting illumination light irradiated by the light source 12a toward the illumination optical system 13. As the light source 12a, a variety of high illuminance discharge lamps that irradiates white light are used such as an ultrahigh pressure mercury lamp, a halide lamp, or a xenon lamp.

The illumination optical system 13 includes a condenser lens 23, a color wheel 24, an optical integrator 25 and a relay lens 26. The condenser lens 23 condenses illumination light irradiated from the light source unit 12.

The color wheel 24 splits the illumination light condensed by the condense lens 23 into three colors, R (red), G (green) and B (blue), on a time division basis. The color wheel 24 is a disc-shaped board 24a having three color filters, an R filter for transmitting R light alone, a G filter for transmitting G light alone and a B filter for transmitting B light alone arranged thereon in equal distance from the rotation center of the board 24a. At the center of the board 24a is fixed the supporting shaft of a motor 24b. The rotation start timing and rotation speed of the motor 24b are controlled by the microcomputer 19. Rotation of the color wheel 24 causes color filters to be sequentially inserted into an optical path in a selective way. This splits illumination light into three colors R, G, B on a time division basis. Illumination rays of split colors are sequentially irradiated toward the image light generating unit 14 through the optical integrator 25 and the relay lens 26.

The optical integrator 25 embodies the invention and makes uniform the illuminance distribution (energy distribution) of the illumination light of each color split by the color wheel 24. Details of this operation will be given later. The illuminance distribution of illumination light has a nearly uniform intensity without being weakened as the illumination light goes away from the illumination optical axis OA in its perpendicular direction. The illumination light emitted from the optical integrator 25 is incident on the image light generating unit 14 through the relay lens 26.

The image generating unit 14 includes a total reflection prism 28 and a DMD 29. The total reflection prism 28 totally reflects the incident light incident through the relay lens 26 to DMD 29, and transmits the reflected light reflected on the DMD 29. The total reflection prism 28 includes for example two triangle prisms having different refractive indexes. On the boundary of these two triangle prisms is formed a reflective plane 28a. The incident light has a larger incident angle than its critical angle so that it is totally reflected on the reflective plane 28a and is incident on the DMD 29. On the other hand, the reflected light reflected on the DMD 29 has a smaller incident angle than its critical angle so that it passes through the reflective plane 28a.

The DMD 29 is driven by the microcomputer 19. The DMD 29 has numerous mirror elements (not shown) corresponding to pixels arranged on its light-receiving surface in a matrix shape. Each mirror element changes its angle based on the picture signals to change the reflection direction of the received illumination light. In case pixels are to be displayed, the mirror elements are placed in on position and received light is reflected as on light toward the reflection optical system 15. On the other hand, in case pixels are not to be displayed, the mirror elements are placed in off position and received light is reflected as of light toward a direction away from the reflection optical system 15. The image light includes a group of on light rays directed to the reflection optical system 15.

The reflection optical system 15 includes a plurality of lens groups (not shown) arranged on an optical axis and a lens moving mechanism for performing scaling and focusing. The image light generated by the DMD 29 is formed on a screen 30 by the reflection optical system 15 and an image (not shown) is displayed on the screen 30.

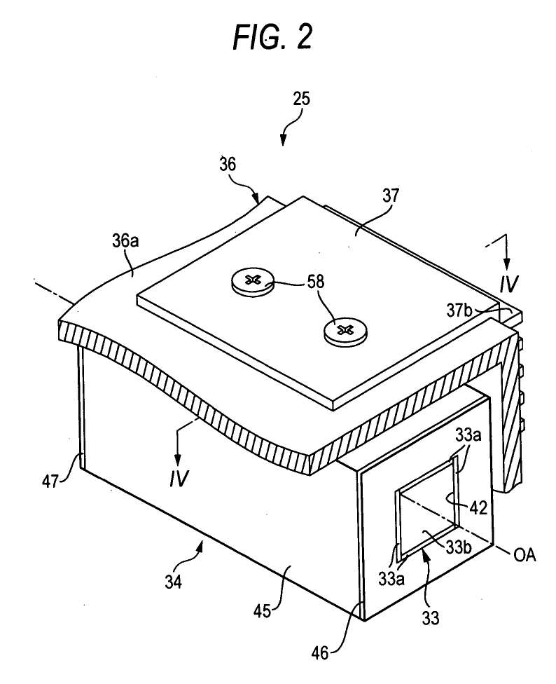

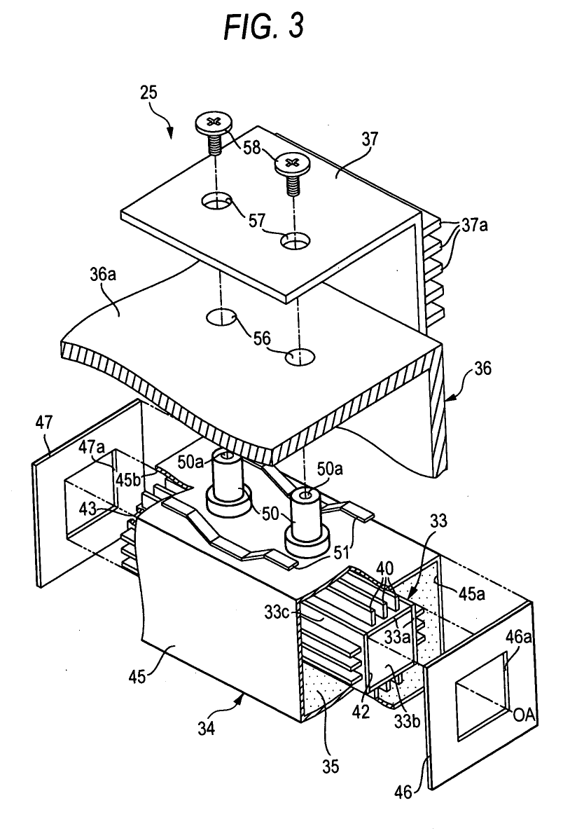

The optical integrator 25 as an exemplary embodiment of the invention will be described referring to FIGS. 2 and 3. FIG. 2 is a perspective view of the optical integrator 25. FIG. 3 is an exploded perspective view of the optical integrator 25. The optical integrator 25 includes an integral rod 33, a rod storage case 34, a cooling system 35, a resin housing 36, and a heat sink 37.

The integral rod 33 is a hollow rod extending in a direction parallel to the irradiation optical axis OA and includes a combination of four long plate-like glass plates 33a bonded together with an adhesive so that the cross section of the glass plates will form a substantially rectangular shape. Material of the glass plate 33a is not particularly limited but optical glass that is low-cost and easy to process is used to form the glass plate 33a. The inner surface of each glass plate 33a is coated with a reflective film (not shown). A rod inner surface 33b of the integral rod 33 serves as a mirror surface (reflective surface). On an outer surface of each glass plate 33a, that is, on the rod outer surface 33c of the integral rod 33 (refer to FIG. 3) protrude a plurality of heat-radiating fins 40 extending in a direction parallel to the illumination optical axis OA. This will be detailed later.

At both ends of the integral rod 33 are respectively formed a light-receiving opening 42 and a light-emitting opening 43 in a substantially rectangular shape. Illumination light incident on the light receiving opening 42 has its illuminance distribution made uniform while repeating internal surface reflection on the rod inner surface 33b and is emitted from the light-emitting opening 43. This makes uniform the brightness of an image displayed on the screen 30.

The rod storage case 34 houses the integral rod 33 with its openings 42, 43 alone exposed. The rod storage case 34 is a hollow case formed with an arbitrary metal material such as a copper material or aluminum material having high thermal conductivity. The rod storage case 34 includes an optical tube 45 corresponding to a tubular body and covers 46, 47 corresponding to two lids.

The optical tube 45 that has a cross section in a substantially rectangular shape covers the rod outer surface 33c of the integral rod 33 with a spacing from the rod outer surface 33c. On the top surface of the optical tube 45 are provided a boss 50 having a cross section of in a substantially convex shape and a plate spring 51.

The covers 46, 47 are respectively fixed to the end faces of the optical tube 45 with an adhesive so as to airtightly close the openings 45a, 45b of the optical tube 45 (refer to FIG. 3). In this practice, the covers 46, 47 has openings 46a, 47a in the same shape formed thereon as those of the integral rod 33. When the covers 46, 47 are fixed, both ends of the integral rod 33 are fitted into the openings 46a, 47a without a gap by using an adhesive. This retains the integral rod 33 inside of the optical tube 45 and its openings 42, 43 to be exposed out of the rod storage case 34. The gap between the openings 45a, 45b of the optical tube 45 and the rod outer surface 33c are airtightly closed.

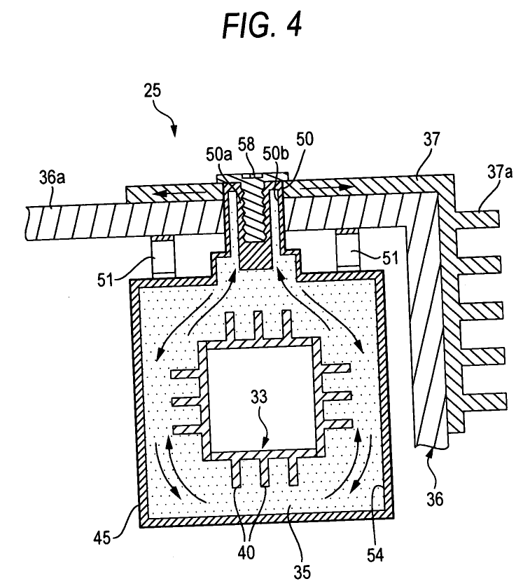

When the gap is airtightly closed by the covers 46, 47, an airtight sealed room 54 (refer to FIG. 4) is formed between the optical tube 45 and the rod outer surface 33c. The sealed room 54 is thickly filled with a cooling liquid 35 to prevent the integral rod 33 from heating up (refer to FIG. 3). The cooling liquid 35 may be selected from a variety of liquids for example water, ethylene glycol, diethylene glycol, glycerine, benzel alcohol, silicone oil, and a mixture liquid thereof

The integral rod 33 has its rod outer surface 33c covered with the cooling liquid 35 and is cooled by the cooling liquid 35. In this embodiment, a plurality of heat-radiating fins 40 protrude from the rod outer surface 33c thus enhancing the cooling efficiency of the integral rod 33. The heat of the heated cooling liquid 35 is dissipated from the resin housing 36 housing the rod storage case 34. This operation will be described later.

The resin housing 36 is formed into a substantially tubular shape with an arbitrary resin material such as vinyl chrolide, acrylic resin, fluororesin, or heat-resistant elastomer (a general view is not shown). The resin housing 36 may house the condenser lens 23, the color wheel 24 and the relay lens 26 constituting the illumination optical system 12. In the wall 36a constituting the top surface of the resin housing 36 is formed a penetration hole 56 engaging with the tip of the boss 50 on the top surface of the rod storage case 34. In other words, the rod storage case 34 is retained on the inner surface of the wall 36a of the resin housing 36.

The boss 50 corresponds to a retaining member. Same as the rod storage case 34, the boss 50 is formed with an arbitrary metal material such as a copper material or aluminum material having high thermal conductivity and is formed integrally with the rod storage case 34. The boss 50 is provided with a female screw 50a and a liquid flow-in room 50b in communication with the sealed room 54 (refer to FIG. 4). The boss 50 has its tip projected on the outer surface of the wall 36a through the penetration hole 56 when engaged with the penetration hole 56. In this embodiment, the heat accumulated in the cooling liquid 35 in the sealed room 54 is dissipated from the resin housing 36 through the boss 50. To this end, the heat sink 37 in contact with the boss 50 is arranged on the outer surface of the wall 36a of the resin housing 36.

The heat sink 37 has a penetration hole 57 engaging with the tip of the boss 50 and a plurality of heat-radiating fins 37a. When the female screw 50a of the boss 50 is threadedly engaged with the male screw 58 with tip of the boss 50 fitted into the penetration holes 56, 57, the rod storage case 34 and the heat sink 37 are coupled together so as to pinch the wall 36a of the resin housing 36. In this embodiment, the length of the tip of the boss 50 is formed greater than the thickness of the wall 36a plus the thickness of the heat sink 37. Thus, the rod storage case 34 is energized downward in the figure by the plate spring 51. In this practice, the male screw 58 works as a locking mechanism so that the rod storage case 34 is retained in position and the center axis (not shown) of the integral rod 33 is aligned with the illumination optical axis OA.

As shown in FIG. 4, the cooling liquid 35 heated by the integral rod 33 is subjected to buoyant force and flows into the liquid flow-in room 50b in the boss 50 located above. The heat of the cooling liquid 35 in the flow-in room 50b is dissipated from the heat sink 37 through the wall of the boss 50 and out of the resin housing 36. This generates convection of the cooling liquid 35 in the sealed room 54. In the convection process where the high-temperature part and low-temperature part of the cooling liquid 35 circulate in the sealed room 54 and the liquid flow-in room 50b to efficiently cool the integral rod 33. In other words, by retaining the rod storage case 34 on the wall 36a constituting the top surface of the resin housing 36, it is possible to dissipate the heat of the cooling liquid 35 from the resin housing 36 by using the convection of the cooling liquid 35. To enhance the cooling efficiency, a cooling wind may be blown against the heat-radiating fins 37a of the heat sink 37 while continuing to protect the interior of the projector 10 against dust. Heat-conductive grease may be applied to the periphery of the boss 50 or to the inner surface of the penetration hole 57 for enhanced heat transfer from the boss 50 to the heat 37.

Operation of this embodiment will be described. When the projector 10 is powered on, the light source 12a of the light source unit 12 comes on. At the same time the DMD 29 is driven based on the picture signal input to the picture signal receiver 18, the color wheel 24 is rotated with the driving timing of the DMD 29. The illumination light irradiated from the light source unit 12 is condensed by the condenser lens 23 and is incident on the color wheel 24. The illumination light incident on the color wheel 24 passes through filters of three colors R, G, B and split into three light components of the three colors R, G, B on a time division basis and is incident on the integral rod 33 of the optical integrator 25.

The illumination light of each color incident on the light receiving opening 42 of the integral rod 33 has its illuminance distribution made uniform while repeating internal surface reflection on the rod inner surface 33b and is emitted from the light emitting opening 43. In this practice, the light receiving opening 42 and the light emitting opening 43 of the integral rod 33 are exposed out of the rod storage case 34 in this embodiment. It is thus possible to enhance the use efficiency of illumination light compared with a case where the integral rod 33 is accommodated in a transparent rod storage case.

Illumination light emitted from the integral rod 33 is incident on the total reflection prism 28 through the relay lens 26. The illumination light incident on the total reflection prism 28 is reflected on the reflective surface 28a and is incident on the DMD 29. On the light receiving surface of the DMD 29 is reflected incoming light reflected as on light toward the reflection optical system 15. The reflected on light (image light) is projected on the screen 30 through the reflection optical system 15 and an image is displayed on the screen 30.

In this practice, according to this embodiment, the airtight sealed room 54 is formed between the rod outer surface 33c of the integral rod 33 and the rod storage case 34. The sealed room 54 is filled with the cooling liquid 35. A plurality of heat-radiating fins 40 are projected on the rod outer surface 33c. The heat of the heated cooling liquid 35 is dissipated from the boss 50 and the heat sink 37 to outside the resin housing 36 by using the convection of the cooling liquid 35, thus efficiently cooling the integral rod 33. As a result, it is possible to suppress a rise in the temperature of the integral rod 33 even in case a high illuminance discharge lamp is used as the light source 12a of the light source unit 12. This allows the glass plate 33a constituting the integral rod 33 to be formed with optical glass that is low-cost and easy to process.

This embodiment is advantageous in that dustproof capability is enhanced because an air intake opening is not required on the projector housing 10a to cool the integral rod 33. Further, there remains no fear of dust and foreign matter accumulated inside the projector 10 being stirred up by the cool wind used to cool the integral rod 33 thus causing the dust and foreign matter to adhere to another optical system.

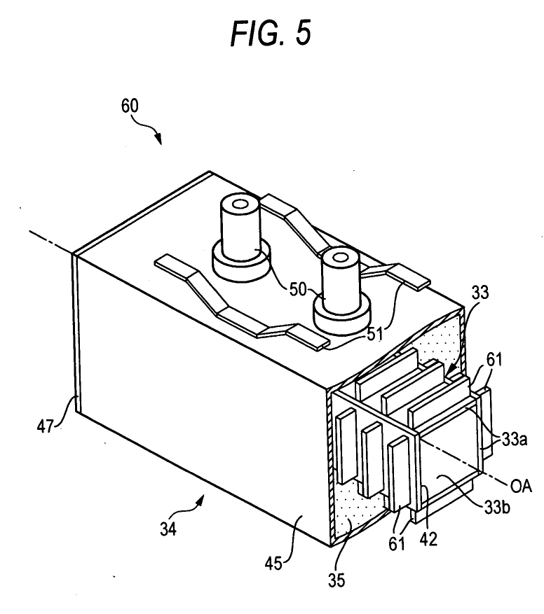

While the heat-radiating fins 40 protruding from the rod outer surface 33c of the integral rod 33 extends in a direction parallel to the illumination optical axis OA in this embodiment, this configuration may cause the heat-radiating fins to obstruct the convection of the cooling liquid 35. Thus, like the optical integrator 60 shown in FIG. 5, a plurality of heat-radiating fins 61 extending in a direction orthogonal to the illumination optical axis OA may be formed on the rod outer surface 33c with a spacing. Here, the optical integrator 60 has substantially the same structure as the optical integrator 25 except for the heat-radiating fins 61. The same members are given the same signs and the corresponding description is omitted.

Each heat-radiating fin 61 extends in a direction orthogonal to the illumination optical axis OA so that it is substantially parallel to the direction of convection of the cooling liquid 35. This eliminates the fear of convention of the cooling liquid 35 being obstructed. As a result, it is possible to enhance the cooling efficiency of the integral rod 33.

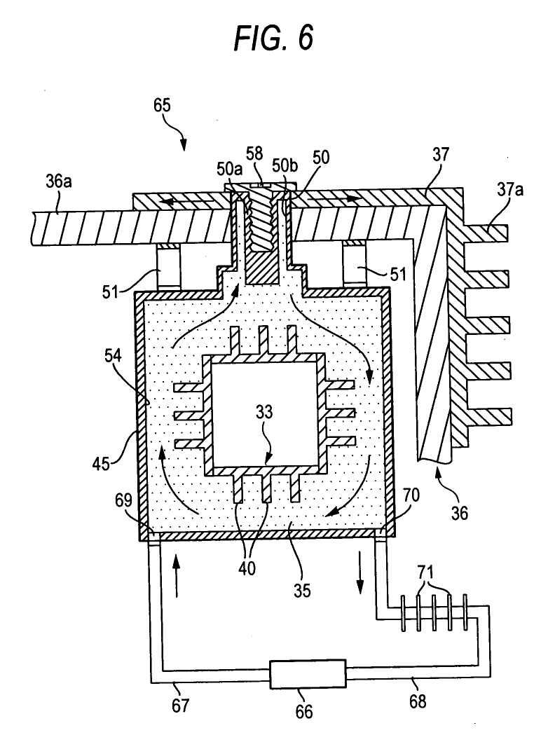

While convection of the cooling liquid 35 is used to cause the high-temperature part and low-temperature part of the cooling liquid 35 to circulate in the sealed room 54 and the liquid flow-in room 50b in this embodiment, the invention is not limited thereto. For example, like the optical integrator 65 shown in FIG. 6, the cooling liquid 35 may circulate both outside and inside of the rod storage case 34. The same members of the optical integrator 25 are given the same signs and the corresponding description is omitted.

The optical integrator 65 includes, outside the rod storage case 34, a circulating device 66, a liquid feed pipe 67, and a return pipe 68. The pipes 67, 68 each has one end connected to the circulating device 66 and has the other end connected to a liquid inlet (flow inlet) 69 and a liquid outlet (flow outlet) 70 formed on the bottom of the rod storage case 34. The liquid inlet 69 and the liquid outlet 70 are in communication with the sealed room 54. When the circulating device 66 is driven, the cooling liquid 35 circulates both outside and inside of the rod storage case 34 through the pipes 67, 68.

The return pipe 68 is provided with a plurality of hat-radiating fins 71 in this embodiment. It is possible to cool the heated cooling liquid 35 and return it to the sealed room 54. This further enhances the cooling efficiency of the integral rod 33. Further, in this case, it is not necessary to make use of the convection of the cooling liquid 35 thus allowing the rod storage case 34 to be retained the rod storage case on the inner surface of an arbitrary wall of the resin housing 36. Instead of providing such a circulating device 66, a stirring device such as a screw may be provided in the closed room 54 to stir the cooling liquid 35.

While a hollow rod includes four glass boards 33a is used as the integral rod 33 in the foregoing embodiments, the invention is not limited thereto. For example, a hollow rod whose cross section including five or more glass boards 33 is in a polygonal column shape or a columnar solid rod such as a glass rod may be used. In this case also, it is possible to form the integral rod with optical glass that is low-cost and easy to process, which reduces the manufacturing cost of the optical integrator 25.

While the DLP-system projector 10 using the DMD 29 is described as an example in the foregoing description, the invention is not limited thereto but is applicable to all types of projector including an optical integrator.

It will be apparent to those skilled in the art that various modifications and variations can be made to the described embodiments of the invention without departing from the spirit or scope of the invention. Thus, it is intended that the invention cover all modifications and variations of this invention consistent with the scope of the appended claims and their equivalents.

The present application claims foreign priority based on Japanese Patent Application No. JP2005-212641 filed Jul. 22 of 2005, the contents of which is incorporated herein by reference.

What is claimed is:

1. An optical integrator comprising:
an integral rod on an optical axis of illumination light irradiated from a light source, the integral rod extending in a direction parallel to the optical axis and making the illumination light entering therein to have a uniform illuminance distribution,
a storage case comprising: a tubular body that houses the integral rod, wherein the tubular body covers an outer surface of the integral rod parallel to the optical axis with a spacing from the outer surface of the integral rod; and two lids, each of the two lids occupying a gap between an opening of the tubular body and the outer surface of the integral rod so as to form a sealed room with the tubular body, the outer surface of the integral rod and the two lids, and
a cooling liquid filled in the room.

2. The optical integrator according to claim 1, comprising:
a housing that houses the storage case, the housing having a penetration hole in one wall thereof, the one wall constituting a plane of the housing;
a retaining member on an outer surface of the housing, the retaining member engaging with the penetration hole to retain the storage case on an inner surface of the one wall, a part of the retaining member being exposed outside of an outer surface of the one wall through the penetration hole; and
a heat sink in contact with the part of the retaining member exposed outside of the outer surface of the one wall.

3. The optical integrator according to claim 2, wherein the retaining member has a cooling liquid flow-in room connecting to the sealed room.

4. The optical integrator according to claim 2, wherein the one wall of the housing is included in a top surface of the housing.

5. The optical integrator according to claim 1, wherein the integral rod is a hollow rod having: a light-receiving opening in which the illumination light from the light source enters; an inner surface that internally reflects the illumination light entering from the light-receiving opening to make the illumination light uniform; a light-emitting opening from which the illumination light made uniform is emitted; and an outer surface having a plurality of heat-radiating fins, each of the heat-radiating fins having a long plate-like shape and protruding from the outer surface.

6. The optical integrator according to claim 5, wherein each of the heat-radiating fins extends in a direction orthogonal to the optical axis.

7. The optical integrator according to claim 1, wherein
the storage case has a flow outlet and flow inlet of the cooling liquid, the flow outlet and flow inlet connecting to the sealed room, and
the optical integrator comprises: a circulating unit that circulates the cooling liquid to flow out of the storage case through the flow outlet and to flow into the storage case through the flow inlet; and a cooling unit that cools the cooling liquid flowing out through the flow outlet.

8. A projector comprising: a controller; a light source unit; an illumination optical system comprising an optical integrator according to claim 1; an image light generating unit; and a projection optical system.
